(19) United States
(12) Patent Application Publication
(10) Pub. No.: US 2025/0192417 A1
(43) Pub. Date: Jun. 12, 2025

(54) ANTENNA STRUCTURE AND ELECTRONIC DEVICE INCLUDING SAME

(71) Applicant: SAMSUNG ELECTRONICS CO., LTD., Suwon-si (KR)

(72) Inventors: Jangsun YOO, Suwon-si (KR); Hakjin KIM, Suwon-si (KR); Junghwan PARK, Suwon-si (KR); Moonhee LEE, Suwon-si (KR); Myeonggil LEE, Suwon-si (KR); Heeseung LEE, Suwon-si (KR); Gun LIM, Suwon-si (KR)

(21) Appl. No.: 19/059,682

(22) Filed: Feb. 21, 2025

Related U.S. Application Data
(63) Continuation of application No. PCT/KR2023/009432, filed on Jul. 4, 2023.

(30) Foreign Application Priority Data
Aug. 25, 2022 (KR) 10-2022-0106911
Sep. 16, 2022 (KR) 10-2022-0117411

(51) Int. Cl. H01Q 1/22; H01Q 13/10

(52) U.S. Cl. CPC H01Q 1/2266; H01Q 13/10

(57) ABSTRACT

According to various embodiments of the present disclosure, an electronic device includes a first plate and a second plate that is disposed so that a first slot structure is formed between at least one part thereof and the first plate. The electric device further includes a non-metallic first inner member that is coupled to the first plate and the second plate, and is disposed so that at least one part thereof faces the first slot structure. The electronic device further includes a first antenna pattern that is disposed on a different part of the first inner member facing in the opposite direction to the at least one part of the first inner member. Various other embodiments are possible.

### CROSS-REFERENCE TO RELATED APPLICATIONS

This application claims priority to International Patent Application No. PCT/KR2023/009432, filed on Jul. 4, 2023, Korean Patent Application No. 10-2022-0106911, filed on Aug. 25, 2022, and Korean Patent Application No. 10-2022-0117411, filed on Sep. 16, 2022, and all the benefits accruing therefrom under 35 U.S.C. § 119, the contents of which in their entirety are herein incorporated by reference.

### BACKGROUND

Various embodiments of the disclosure relate to an electronic device, for example, an antenna structure and an electronic device including the same.

Thanks to the remarkable development of information and communication technology and semiconductor technology, the proliferation and use of various electronic devices are rapidly increasing. In particular, recent electronic devices have been developed to enable communication while being carried.

An electronic device may refer to a device that executes a specific function according to a loaded program, such as a home appliance, an electronic notebook, a portable multimedia player, a mobile communication terminal, a tablet PC, a video/audio device, a desktop/laptop computer, or a vehicle navigation device. For example, these electronic devices may output stored information as sound or an image. As the integration level of electronic devices increases and high-speed, large-capacity wireless communication becomes more common, a single electronic device, such as a mobile communication terminal, may recently be equipped with various functions. For example, in addition to a communication function, an entertainment function, such as games, a multimedia function, such as music/video playback, a communication and security function for mobile banking, and a function, such as schedule management or an electronic wallet, are integrated in a single electronic device. These electronic devices are being miniaturized so that users may carry them conveniently.

### SUMMARY

According to various embodiments of the disclosure, an electronic device includes a first plate, a second plate, a first inner member, or a first antenna pattern. The second plate is disposed to form a first slot structure between the first plate and at least a portion of the second plate. The first inner member is coupled to the first plate and the second plate. At least a portion of the first inner member is disposed to face the first slot structure. The first antenna pattern is disposed on another portion facing an opposite direction to the at least portion of the first inner member.

According to various embodiments of the disclosure, an electronic device includes a first plate, a second plate, a first inner member, a circuit board, an antenna structure, or a feed portion. The second plate is disposed to form a first slot structure between the first plate and at least a portion of the second plate. The first inner member is coupled to the first plate and the second plate. At least a portion of the first inner member is disposed to face the first slot structure. The circuit board is disposed between the first plate and the second plate. The antenna structure is formed in at least a portion of the first inner member. The feed portion is configured to feed an antenna signal from the circuit board to the antenna structure.

### BRIEF DESCRIPTION OF THE DRAWINGS

The above and other advantages and features of this disclosure will become more apparent by describing in further detail embodiments thereof with reference to the accompanying drawings, in which:

FIG. 1 is a block diagram illustrating an electronic device in a network environment according to various embodiments.

FIG. 2 is a perspective view illustrating an electronic device according to an embodiment of the disclosure.

FIG. 3 is a disassembled perspective view illustrating a first housing according to an embodiment of the disclosure.

FIG. 4 is a perspective view illustrating a first housing and an inner member according to an embodiment of the disclosure.

FIG. 5 is a combined perspective view illustrating a first housing according to an embodiment of the disclosure.

FIG. 6 is a cross-sectional view illustrating the first housing according to an embodiment of the disclosure, taken along line A-A′ of FIG. 5.

FIG. 7 is a perspective view illustrating a first inner member and an antenna structure according to an embodiment of the disclosure.

FIG. 8 is a perspective view illustrating a first inner member and an antenna structure according to an embodiment of the disclosure.

FIG. 9 is a perspective view illustrating a first inner member and an antenna structure according to an embodiment of the disclosure.

FIG. 10 is a front view illustrating a first inner member and an antenna structure according to an embodiment of the disclosure.

FIG. 11A is a rear view illustrating a first inner member and an antenna structure according to an embodiment of the disclosure.

FIG. 11B is a rear view illustrating a first inner member and an antenna structure according to an embodiment of the disclosure.

FIG. 12 is a front view illustrating a first inner member and an antenna structure according to an embodiment of the disclosure.

FIG. 13A is a rear view illustrating a first inner member and an antenna structure according to an embodiment of the disclosure.

FIG. 13B is a rear view illustrating a first inner member and an antenna structure according to an embodiment of the disclosure.

FIG. 13C is a rear view illustrating a first inner member and an antenna structure according to an embodiment of the disclosure.

FIG. 14A is a rear view illustrating a first inner member and an antenna structure according to an embodiment of the disclosure.

FIG. 14B is a rear view illustrating a first inner member and an antenna structure according to an embodiment of the disclosure.

FIG. 15 is a cross-sectional view illustrating a first housing according to an embodiment of the disclosure.

FIG. 16 is a disassembled perspective view illustrating a first housing according to an embodiment of the disclosure.

FIG. 17 is a disassembled perspective view illustrating a first housing according to an embodiment of the disclosure.

FIG. 18A is a diagram illustrating a second plate according to an embodiment of the disclosure.

FIG. 18B is a diagram illustrating a state in which a rubber member is coupled to a second plate according to an embodiment of the disclosure.

FIG. 19 is a disassembled perspective view illustrating a second housing according to an embodiment of the disclosure.

FIG. 20 is a cross-sectional view illustrating a first housing according to an embodiment of the disclosure.

FIG. 21 is a diagram of a graph comparing the antenna performance of an electronic device in terms of efficiency (y-axis) at different frequencies (x-axis) according to an embodiment of the disclosure with the antenna performance of a general electronic device.

### DETAILED DESCRIPTION

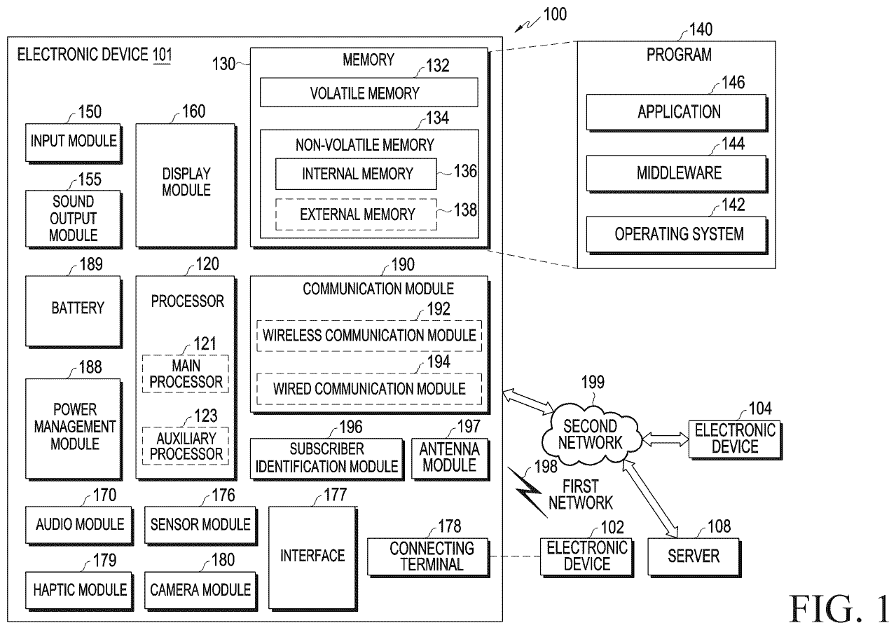

FIG. 1 is a block diagram illustrating an electronic device 101 in a network environment 100 according to various embodiments.

Referring to FIG. 1, the electronic device 101 in the network environment 100

may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning.

The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

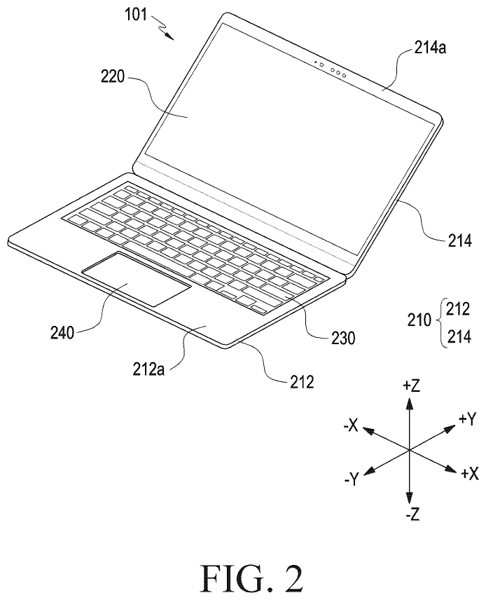

In FIGS. 2 to 20, the Cartesian coordinate system is illustrated, for convenience of description. In FIGS. 2 to 20, an X-axis direction may be defined and interpreted as a width direction of an electronic device or components of the electronic device, a Y-axis direction may be defined and interpreted as a longitudinal direction of the electronic device or the components of the electronic device, and a Z-axis direction may be defined and interpreted as a thickness direction of the electronic device or the components of the electronic device. However, embodiments of the disclosure are not limited to these directions.

FIG. 2 is a perspective view illustrating an electronic device according to an embodiment of the disclosure.

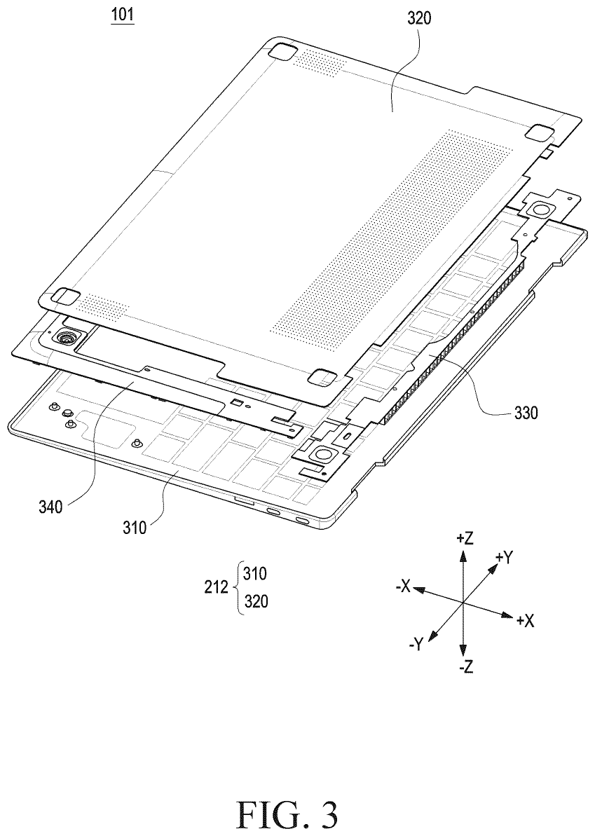

The embodiment of FIG. 2 may be combined with the embodiment of FIG. 1 or one or more of the embodiments of FIGS. 3 to 21.

Referring to FIG. 2, the electronic device 101 may include a housing 210, a display 220, a plurality of keyboard buttons 230, and a touch pad module 240.

According to an embodiment, the electronic device 101 may be a laptop computer, a notebook computer, or a portable terminal. The configurations of the electronic device 101 and the display 220 in FIG. 2 may be partially or wholly identical to those of the electronic device 101 of FIG. 1, the display module 160, and the antenna module 197 in FIG. 1. The configuration of the plurality of keyboard buttons 230 in FIG. 2 may be partially or wholly identical to that of the input module 150 in FIG. 1. The configuration of the touch pad module 240 in FIG. 2 may be partially or wholly identical to that of the input module 150 in FIG. 1. The embodiment of FIG. 2 may be combined with the embodiment of FIG. 1. For example, the embodiment of FIG. 2 may additionally include components of the embodiment of FIG. 1.

According to an embodiment, the housing 210 may form at least a portion of the exterior of the electronic device 101 or support a component (e.g., the touch pad module 240) of the electronic device 101. According to an embodiment, the housing 210 may be formed of a metal material. According to an embodiment, the housing 210 may be defined and referred to as a metal housing. According to an embodiment, the housing 210 may include a metal region.

According to an embodiment, the housing 210 may accommodate at least one of the display 220, the plurality of keyboard buttons 230, or the touch pad module 240.

According to an embodiment, the electronic device 101 may be open or closed. For example, the housing 210 may include a first housing 212 and a second housing 214 rotatably connected to the first housing 212. According to an embodiment, the electronic device 101 may include a hinge module (not shown) connected to the housing 210. For example, the hinge module may be connected to the first housing 212 and the second housing 214 and provide a structure in which the first housing 212 and the second housing 214 are rotatable relative to each other. According to an embodiment, the first housing 212 may be configured to rotate at a specified angle (e.g., 0 to substantially 180 degrees or 0 to substantially 360 degrees) with respect to the second housing 214. According to an embodiment, the second housing 214 may be defined and interpreted as rotating at the specified angle with respect to the first housing 212. For example, a first front surface 212a of the first housing 212 may face a second front surface 214b of the second housing 214 (e.g., when the electronic device 101 is in a closed state).

According to an embodiment, the housing 210 may be formed of a metal material having a selected level of rigidity. According to an embodiment, the housing 210 may be formed of a metal material or non-metal material having a selected level of rigidity. According to an embodiment, at least a portion of the electronic device 101 formed of the metal material may provide a ground plane, and may be electrically connected to a ground line formed on a PCB. For example, the housing 210 may be electrically connected to the PCB through a capacitive component.

According to an embodiment, at least a portion of the display 220 may be disposed within the second housing 214. For example, at least a partial area of the display 220 may be visually exposed to the outside of the electronic device 101 through the second housing 214. According to an embodiment, the display 220 may be a flexible display having at least a partial area deformable into a flat or curved surface. For example, the display 220 may be a foldable or rollable display.

According to an embodiment, the display 220 may be coupled to or disposed adjacent to a touch sensing circuit, a pressure sensor capable of measuring the intensity (pressure) of a touch, and/or a digitizer configured to detect a magnetic stylus pen.

According to an embodiment, the plurality of keyboard buttons 230 may each detect a user input (e.g., pressure). According to an embodiment, the plurality of keyboard buttons 230 may be disposed on the first housing 212. According to an embodiment, when the electronic device 101 is in the closed state, the plurality of keyboard buttons 230 may face the display 220. According to an embodiment, the plurality of keyboard buttons 230 may be defined and interpreted as a plurality of keyboard keycaps. The configuration of the plurality of keyboard buttons 230 in FIG. 2 may be wholly or partially identical to that of the input module 150 in FIG. 1.

According to an embodiment, the touch pad module 240 may be configured to detect or receive a user input. According to an embodiment, the touch pad module 240 may include a capacitive touch sensor, a resistive sensing-based touch sensor, an optical touch sensor, or a surface acoustic wave touch sensor. For example, the touch pad module 240 may detect current, pressure, light, and/or vibration caused by a user input applied to the touch pad module 240, and a processor (e.g., the processor 120 of FIG. 1) and/or the touch pad module 240 may determine the user input based on a change in the detected current, pressure, light, and/or vibration.

According to an embodiment, the processor (e.g., the processor 120 of FIG. 1) and/or the touch pad module 240 may determine the location (e.g., XY coordinates) of a user input. According to an embodiment, the touch pad module 240 may detect pressure on the touch pad module 240. According to an embodiment, when an external object (e.g., the user's finger or stylus) directly contacts or is in close proximity to a surface of the touch pad module 240, the touch pad module 240 may detect the external object.

According to an embodiment, the touch pad module 240 may be accommodated in the housing 210. For example, the touch pad module 240 may be connected to the first housing 212 and at least partially exposed to the outside of the first housing 212. According to an embodiment, the touch pad module 240 may be located adjacent to the plurality of keyboard buttons 230. According to an embodiment, when the electronic device 101 is in the closed state, at least a portion of the touch pad module 240 may face the display 220. The configuration of the touch pad module 240 may be wholly or partially identical to that of the input module 150 in FIG. 1.

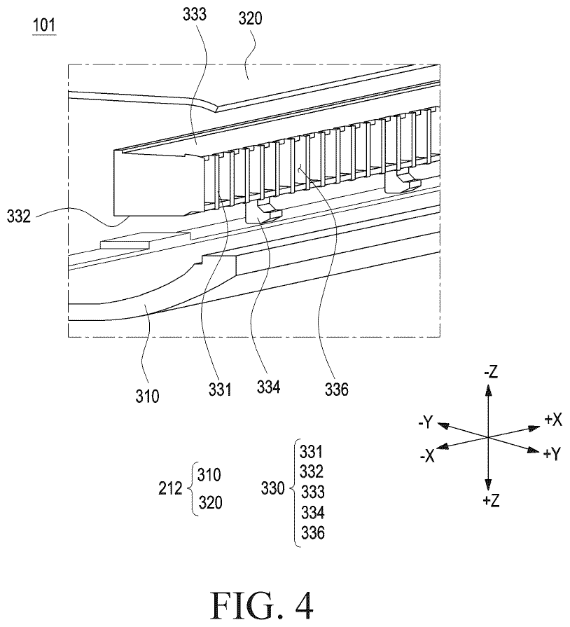

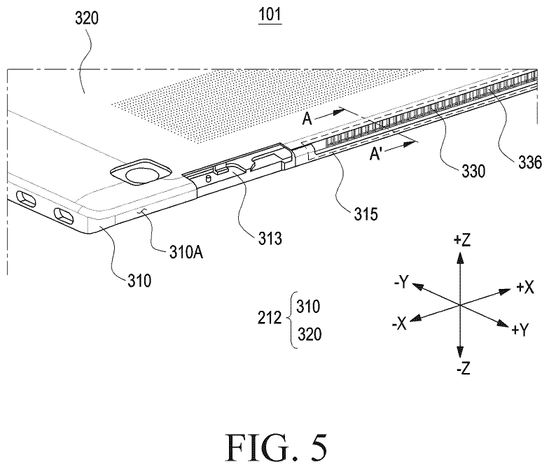

FIG. 3 is a disassembled perspective view illustrating a first housing according to an embodiment of the disclosure. FIG. 4 is a perspective view illustrating a first housing and an inner member according to an embodiment of the disclosure. FIG. 5 is a combined perspective view illustrating a first housing according to an embodiment of the disclosure.

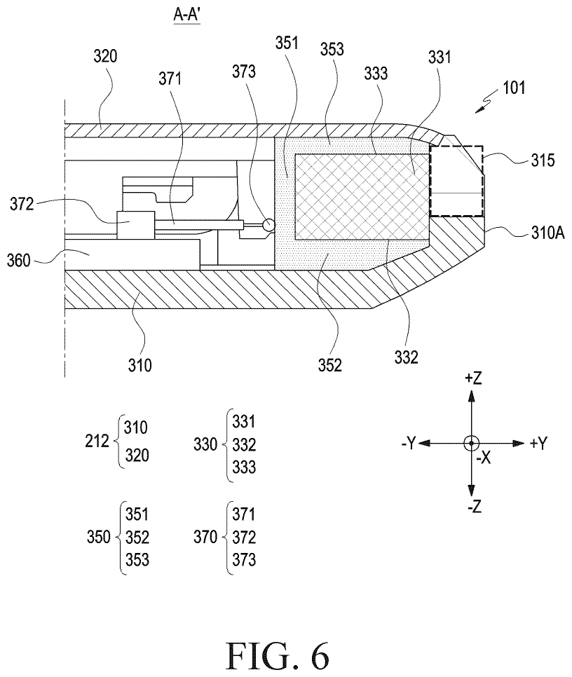

The embodiments of FIGS. 3 to 5 may be combined with one or more of the embodiment of FIGS. 1 and 2 or one or more of the embodiments of FIGS. 6 to 21.

Referring to FIGS. 3 to 5, the electronic device 101 (e.g., the electronic device 101 of FIGS. 1 and 2) may include the first housing 212 (e.g., the first housing 212 of FIG. 2), a first inner member 330, or a second inner member 340.

Referring to FIG. 3, the first housing 212 may include a first plate 310 or a second plate 320. The first plate 310 and the second plate 320 may be coupled to each other to form an internal space of the first housing 212. A circuit board (e.g., a circuit board 360 of FIG. 6) may be disposed in the internal space.

According to an embodiment, the first plate 310 may include a plurality of keyboard holes in which a plurality of keyboard buttons (e.g., the keyboard buttons 230 of FIG. 2) are disposed. According to an embodiment, the first plate 310 may be formed of a metal material.

According to an embodiment, the second plate 320 may be configured to be coupled to the first plate 310. The second plate 320 may be formed of a metal material. According to an embodiment, the second plate 320 may be coupled to the first plate 310 through the first inner member 330 or the second inner member 340.

According to an embodiment, the first inner member 330 and the second inner member 340 may be formed of a non-metal material (e.g., a plastic material). For example, the first inner member 330 or the second inner member 340 may be manufactured by injection molding.

According to an embodiment, the first inner member 330 may be configured to couple at least one (e.g., edges facing a +Y direction in FIG. 3) of edges of the first plate 310 and the second plate 320. According to an embodiment, the second inner member 340 may be configured to couple one (e.g., edges facing a −X direction in FIG. 3) of the edges of the first plate 310 and the second plate 320.

According to an embodiment, the first inner member 330 or the second inner member 340 may include a coupling structure (e.g., a hook structure 334 of FIG. 4) for coupling to the first plate 310 or the second plate 320.

According to an embodiment, the first inner member 330 may include a plurality of first air holes (e.g., first air holes 336 of FIG. 4). For example, heat generated inside the electronic device 101 (or inside the first housing 212) may be discharged to the outside of the electronic device 101 through the plurality of first air holes formed in the first inner member 330.

Referring to FIG. 4, the first inner member 330 may be disposed between edges of the first plate 310 and the second plate 320.

According to an embodiment, the first inner member 330 may include a plurality of first bulkheads 331, a second bulkhead 332 disposed on ends (e.g., ends facing a +Z direction in FIG. 4) of the plurality of first bulkheads 331, or a third bulkhead 333 disposed on the other ends (e.g., ends facing a −Z direction in FIG. 4) of the plurality of bulkheads 331. According to an embodiment, the first inner member 330 may further include a hook structure 334 protruding from at least a portion of the third bulkhead 333.

According to an embodiment, the plurality of first bulkheads 331 may be spaced apart from each other. For example, the plurality of first bulkheads 331 may be spaced apart from each other in the width direction of the electronic device 101 (e.g., the X-axis direction in FIG. 4). According to an embodiment, the plurality of first bulkheads 331 may be formed to have, but not limited to, a plate shape (or board shape).

According to an embodiment, the second bulkhead 332 may be connected or coupled to the ends (e.g., the ends facing the +Z direction in FIG. 4) of the plurality of bulkheads 331. According to an embodiment, the second bulkhead 332 may be a portion of the first inner member 330 facing the first plate 310. According to an embodiment, the hook structure 334 may be formed to protrude from at least a portion of the second bulkhead 332. According to an embodiment, the hook structure 334 may be fitted into a step or groove formed on the first plate 310. The first inner member 330 may be fixed to at least a portion of the first plate 310 through the hook structure 334.

According to an embodiment, the third bulkhead 333 may be connected or coupled to the other ends (e.g., the ends facing the −Z direction in FIG. 4) of the plurality of bulkheads 331. According to an embodiment, the third bulkhead 333 may be a portion of the first inner member 330 facing the second plate 320. According to an embodiment, the first inner member 330 may include a separate coupling structure for coupling to the second plate 320. The separate coupling structure may be a hook structure or a screw coupling structure.

According to an embodiment, the first inner member 330 may include the plurality of first air holes 336. According to an embodiment, the plurality of first air holes 336 may be holes formed to discharge air inside the electronic device 101 or the first housing 212 to the outside.

For example, the plurality of first air holes 336 may be holes surrounded by the plurality of first bulkheads 331, the second bulkhead 332, or the third bulkhead 333, or some combination thereof. In an embodiment, the plurality of first air holes 336 may be defined as holes penetrating from a front portion (e.g., a portion facing the +Y direction in FIG. 4) of the first inner member 330 to a rear portion (e.g., a portion facing a −Y direction in FIG. 4) thereof. The plurality of first air holes 336 may form paths for discharging air inside the first housing 212 to dissipate heat inside the first housing 212.

Referring to FIG. 5, a state in which the first plate 310 and the second plate 320 are connected through the first inner member 330 is illustrated.

According to an embodiment, at least a portion of the first plate 310 may form a side surface 310A of the first housing 212. According to an embodiment, with the first plate 310 and the second plate 320 coupled to each other, the first housing 212 may include a mounting structure 315 formed therein to be coupled to at least a portion of the hinge module.

According to an embodiment, with the first plate 310 and the second plate 320 coupled to each other, the first housing 212 may include a first slot structure 315 formed in at least a portion thereof. According to an embodiment, at least a portion (e.g., at least a portion of the front portion or a portion facing the +Y direction in FIG. 5) of the first inner member 330 may be exposed to the outside of the electronic device 101 through the first slot structure 315.

According to an embodiment, the first slot structure 315 may be formed by a step formed at edges (e.g., edges facing the +Y direction in FIG. 5) of the first plate 310 and the second plate 320.

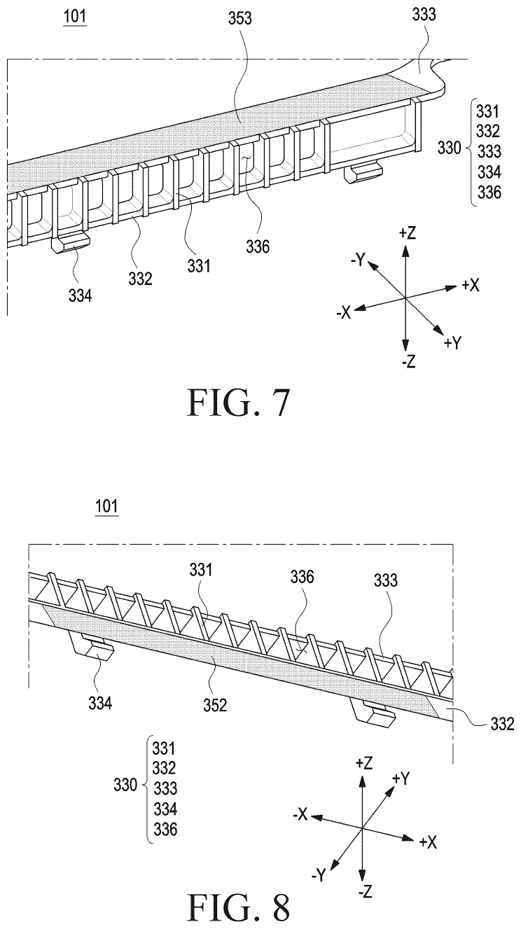

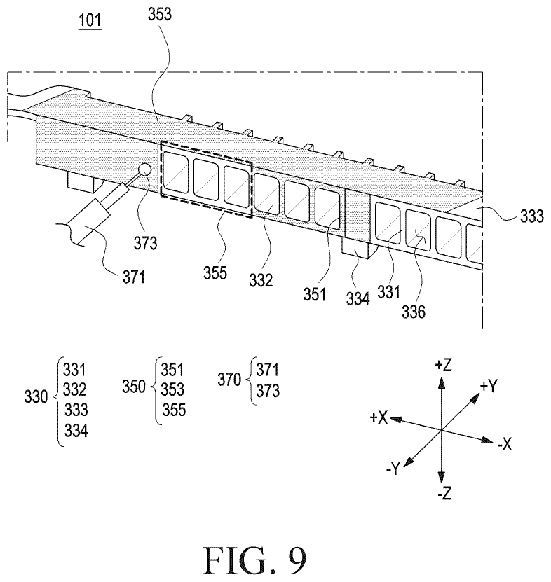

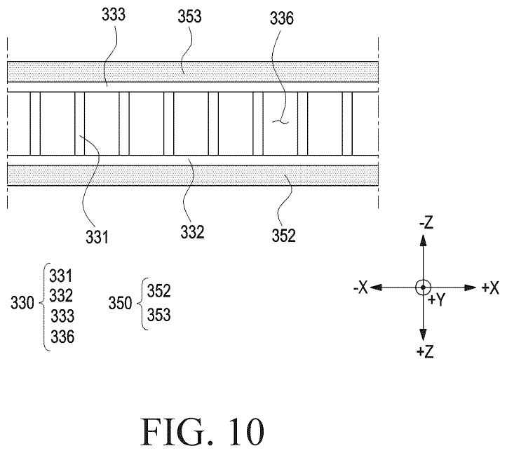

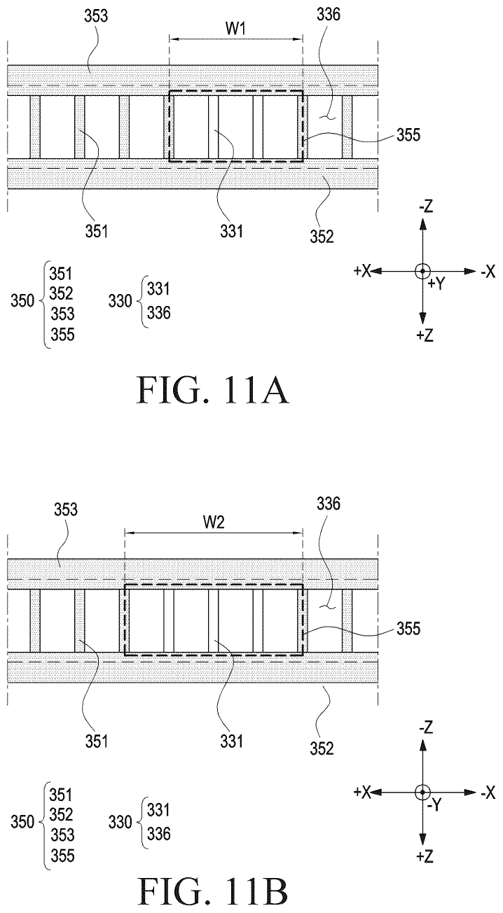

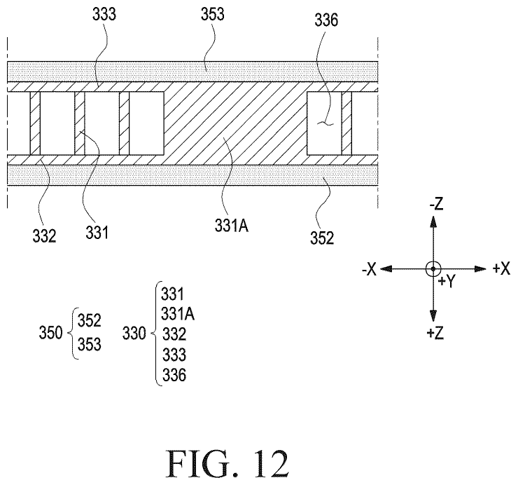

FIG. 6 is a cross-sectional view illustrating the first housing according to an embodiment of the disclosure, taken along line A-A′ of FIG. 5. FIG. 7 is a perspective view illustrating a first inner member and an antenna structure according to an embodiment of the disclosure. FIG. 8 is a perspective view illustrating a first inner member and an antenna structure according to an embodiment of the disclosure. FIG. 9 is a perspective view illustrating a first inner member and an antenna structure according to an embodiment of the disclosure. FIG. 10 is a front view illustrating a first inner member and an antenna structure according to an embodiment of the disclosure. FIG. 11A is a rear view illustrating a first inner member and an antenna structure according to an embodiment of the disclosure. FIG. 11B is a rear view illustrating a first inner member and an antenna structure according to an embodiment of the disclosure.

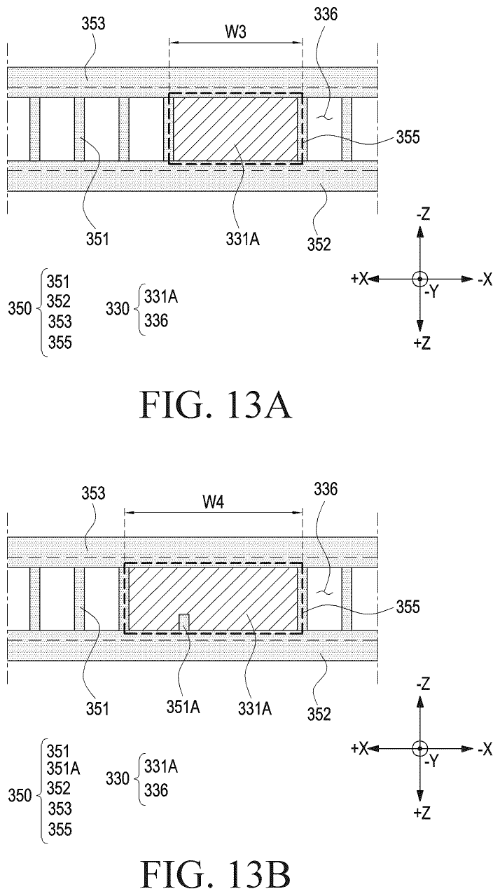

One or more of the embodiments of FIGS. 6 to 11B may be combined with one or more of the embodiments of FIGS. 1 to 5 or one or more of the embodiments of FIGS. 12 to 21.

FIG. 10 is a diagram illustrating the first inner member 330 and an antenna structure 350 of FIGS. 6 to 9, viewed from the +Y direction to the −Y direction in FIGS. 6 to 9, and FIGS. 11A and 11B are diagrams illustrating the first inner member 330 and the antenna structure 350 of FIGS. 6 to 9, viewed from the −Y direction toward the +Y direction in FIGS. 6 to 9.

Referring to FIGS. 6 to 11B, the electronic device 101 (e.g., the electronic device 101 of FIGS. 1 to 5) may include the first housing 212, the first plate 310, the second plate 320, the first inner member 330, the antenna structure 350, the circuit board 360, or a feed portion 370.

The configuration of the first housing 212, the first plate 310, the second plate 320, or the first inner member 330 in FIGS. 6 to 11B may be partially or wholly identical to that of the first housing 212, the first plate 310, the second plate 320, or the first inner member 330 in FIGS. 3 to 5.

According to an embodiment, the first housing 212 may include the first slot structure 315 (e.g., the first slot structure 315 of FIG. 5) formed in at least a portion thereof. For example, the first slot structure 315 may be a slot formed on at least a portion of the side surface 310A (e.g., the side surface 310A of FIG. 5) of the first housing 212. For example, the first slot structure 315 may be a step formed between the first plate 310 and the second plate 320.

According to an embodiment, the first inner member 330 may include the plurality of first bulkheads 331 (e.g., the first bulkheads 331 of FIGS. 4 and 5), the second bulkhead 332 (e.g., the second bulkhead 332 of FIGS. 4 and 5), the third bulkhead 333 (e.g., the third bulkhead 333 of FIGS. 4 and 5), or the plurality of first air holes 336.

According to an embodiment, the front portion (e.g., a portion facing the +Y direction in FIG. 6) of the first inner member 330 may at least partially face the first slot structure 315.

According to an embodiment, the plurality of first air holes (e.g., the first air holes 336 of FIGS. 4 and 5) of the first inner member 330 may form paths for discharging air inside the first housing 212, together with the first slot structure 315.

According to an embodiment, an antenna module (e.g., the antenna module 197 of FIG. 1) of the electronic device 101 may include the circuit board 360, the feed portion 370, or the antenna structure 350.

According to an embodiment, the circuit board 360 may be disposed inside the first housing 212. According to an embodiment, the circuit board 360 may include at least one of a PCB, a flexible printed circuit board (FPCB), or a rigid-flexible printed circuit board (RF-PCB).

According to an embodiment, the feed portion 370 may form a conductive path that electrically connects the circuit board 360 and the antenna structure 350. The feed portion 370 may include a first connector 372 connected to the circuit board 360, a second connector 373 connected to a first antenna pattern 351, or a coaxial cable 371 connected to the first connector 372 and the second connector 373.

According to an embodiment, the feed portion 370 may be electrically connected to a communication module (e.g., the communication module 190 of FIG. 1) through the circuit board 360. According to an embodiment, the communication module may feed an antenna signal to the first antenna pattern 351 through the feed portion 370 or tune an antenna signal radiated from the first antenna pattern 351.

According to an embodiment, the antenna structure 350 may include the first antenna pattern 351, a second antenna pattern 352, or a third antenna pattern 353.

According to an embodiment, the first antenna pattern 351 may be a conductive pattern formed on the plurality of first bulkheads 331 of the first inner member 330. According to an embodiment, the first inner member 330 may be defined as having at least a portion facing the first slot structure 315, and the first antenna pattern 351 may be disposed on a portion facing an opposite direction (e.g., the −Y direction in FIG. 6) of the at least portion of the first inner member 330.

According to an embodiment, the first antenna pattern 351 may be disposed on ends (e.g., ends facing the −Y direction in FIG. 6) of the first bulkheads 331. For example, at least a portion of the first antenna pattern 351 may overlap the first slot structure 315 in a direction (e.g., the +Y direction in FIG. 6) from the inside of the electronic device 101 toward the outside. According to an embodiment, the first antenna pattern 351 may be connected to the second connector 373 of the feed portion 370.

According to an embodiment, the second antenna pattern 352 may be a conductive pattern formed on the second bulkhead 332. The second antenna pattern 352 may be formed on a portion of the second bulkhead 332 facing the first plate 310. According to an embodiment, the second antenna pattern 352 may be a pattern extending from the first antenna pattern 351.

According to an embodiment, the second antenna pattern 352 may be in contact with at least a portion of the first plate 310. At least a portion of the first plate 310 formed of a metal material may provide a ground plane for the antenna structure 350.

According to an embodiment, the third antenna pattern 353 may be a conductive pattern formed on the third bulkhead 333. The third antenna pattern 353 may be formed on a portion of the third bulkhead 333 facing the second plate 320. According to an embodiment, the third antenna pattern 353 may be a pattern extending from the first antenna pattern 351.

According to an embodiment, the third antenna pattern 353 may be in contact with at least a portion of the first plate 310. At least a portion of the second plate 320 formed of a metal material may provide a ground plane for the antenna structure 350.

According to an embodiment, the first antenna pattern 351 may be formed on specified first bulkheads 331 among the plurality of first bulkheads 331 without being formed on the remaining bulkheads of the plurality of first bulkheads 331.

Referring to FIG. 9, it is illustrated that the first antenna pattern 351 is formed on some of the plurality of first bulkheads 331 without being formed on first bulkheads 331 located within at least a portion thereof (e.g., a slot region 355). According to an embodiment, the antenna structure 350 may include the slot

region 355 defined as a region where the antenna pattern is not formed (or a region surrounded by the first antenna pattern 351).

According to an embodiment, the antenna structure 350 may operate as a slot antenna by feeding an antenna signal to a portion of the first antenna pattern 351 adjacent to the slot region 355 through the feed portion 370. According to an embodiment, at least a portion of the slot region 355 may overlap the first slot structure 315 in the direction (e.g., the +Y direction in FIG. 9) from the inside of the electronic device 101 toward the outside. Accordingly, an antenna signal transmitted from at least one antenna structure 350 may be radiated to the outside of the electronic device 101 through the first slot structure 315.

According to an embodiment, the at least one antenna structure 350 is formed or disposed on the first inner member 330 for coupling the first plate 310 and the second plate 320, so that the electronic device 101 may secure a free space inside it, compared to a case where a separate structure is included to dispose at least one antenna pattern (or structure). For example, the first antenna pattern 351, the second antenna pattern 352, or the third antenna pattern 353 of the antenna structure 350 may include a laser direct structuring (LDS) antenna.

According to an embodiment, a portion to which the feed portion 370 is connected may be, but not limited to, the first antenna pattern 351 disposed on a portion of the first bulkheads 331 where first air holes 336 are not formed.

Considering tuning of an antenna signal or interference with a surrounding structure, the feed portion 370 may be connected to the second antenna pattern 352 or the third antenna pattern 353, or may be connected to the first antenna pattern 351 via the front portion (e.g., a portion facing the +Y direction in FIG. 9) of the first inner member 330.

Referring to FIGS. 11A and 11B, a width (e.g., a width in the X-axis direction in FIGS. 11A and 11B) of the slot region 355 may be a first width W1 or a second width W2, which is greater than the first width W1.

According to an embodiment, the electronic device 101 may design the width W1 or W2 of the slot region 355 to tune the frequency of an antenna signal in consideration of a target frequency band of the antenna structure 350 operating as a slot antenna or interference caused by an internal structure of the electronic device 101.

According to an embodiment, the slot region 355 may overlap a plurality of first air holes 336 in the direction (e.g., the +Y direction in FIGS. 6 to 11B) from the inside of the electronic device 101 toward the outside.

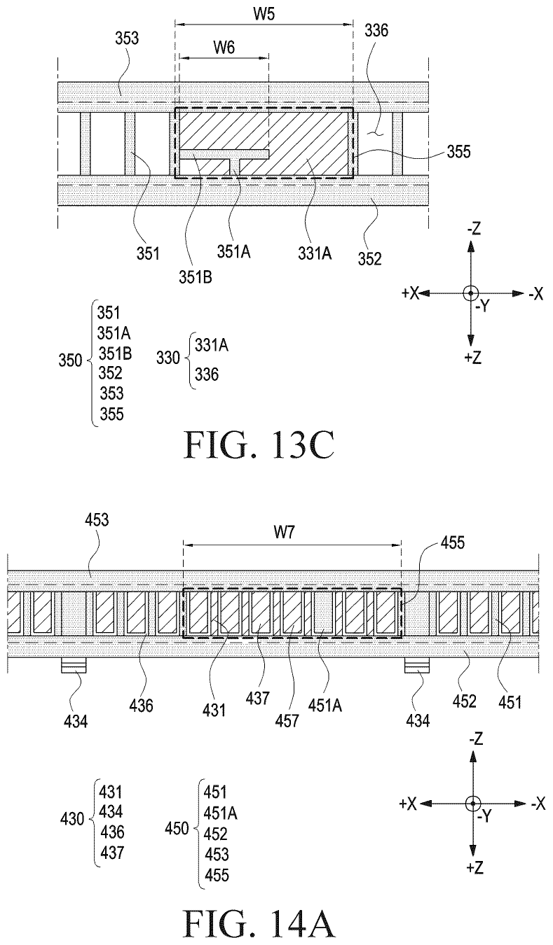

FIG. 12 is a front view illustrating a first inner member and an antenna structure according to an embodiment of the disclosure. FIG. 13A is a rear view illustrating a first inner member and an antenna structure according to an embodiment of the disclosure. FIG. 13B is a rear view illustrating a first inner member and an antenna structure according to an embodiment of the disclosure. FIG. 13C is a rear view illustrating a first inner member and an antenna structure according to an embodiment of the disclosure.

FIG. 12 is a diagram illustrating the first inner member 330 and the antenna structure 350 of FIGS. 6 to 9, viewed from the +Y direction to the −Y direction in FIGS. 6 to 9, and FIGS. 13A to 13C are diagrams illustrating the first inner member 330 and the antenna structure 350 of FIGS. 6 to 9, viewed from the −Y direction to the +Y direction in FIGS. 6 to 9.

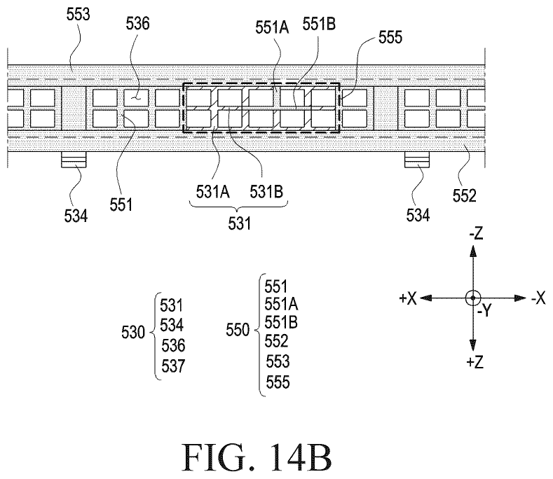

The embodiments of FIGS. 12 to 13C may be combined with one or more of the embodiments of FIGS. 1 to 11B or one or more of the embodiments of FIGS. 14A to 21.

Referring to FIGS. 12 to 13C, an electronic device (e.g., the electronic device 101 of FIGS. 1 to 9) may include the first inner member 330 and the antenna structure 350.

The configuration of the first inner member 330 or the antenna structure 350 in FIGS. 12 to 13C may be partially or wholly identical to that of the first inner member 330 or the antenna structure 350 in FIGS. 6 to 11B.

According to an embodiment, the first inner member 330 may include the plurality of first bulkheads 331 (e.g., the plurality of first bulkheads 331 of FIGS. 6 to 11B), the second bulkhead 332 (e.g., the second bulkhead 332 of FIGS. 6 to 11B), the third bulkhead 333 (e.g., the third bulkhead 333 of FIGS. 6 to 11B), or the plurality of first air holes 336 (e.g., the plurality of first air holes 336 of FIGS. 6 to 11B).

According to an embodiment, the antenna structure 350 may include the first antenna pattern 351 (e.g., the first antenna pattern 351 of FIGS. 6 to 11B), the second antenna pattern 352 (e.g., the second antenna pattern 352 of FIGS. 6 to 11B), the third antenna pattern 353 (e.g., the third antenna pattern 353 of FIGS. 6 to 11B), or the slot region 355 (e.g., the slot region 355 of FIGS. 6 to 11B).

According to an embodiment, at least some (e.g., a first bulkhead 331A) of the plurality of first bulkheads 331 may have a greater width (e.g., a width in the X-axis direction in FIGS. 12 to 13B) than the other first bulkheads 331.

According to an embodiment, a first air hole 336 is not formed on the first bulkhead 331A (hereinafter referred to as the ‘(1-1)^{th} bulkhead 331A’).

According to an embodiment, the slot region 355 may be formed to correspond to the (1-1)^{th} bulkhead 331A. For example, the antenna patterns 351, 352, and 353 of the antenna structure 350 may not be formed on a rear portion (e.g., a portion facing the −Y direction in FIGS. 13A and 13B) of the (1-1)^{th} bulkhead 331A.

For example, the slot region 355 may overlap the first slot structure (e.g., the first slot structure 315 of FIG. 6) in the direction (e.g., the +Y direction in FIG. 6) from the inside of the electronic device (e.g., the electronic device 101 of FIG. 6) toward the outside, but does not overlap the first air holes 336 in the direction (e.g., the +Y direction in FIG. 6).

Referring to FIGS. 13A to 13C, a width (e.g., a width in the X-axis direction in FIGS. 13A and 13B) of the slot region 355 may be a third width W3 or a fourth width W4, which is greater than the third width W3, or a fifth width W5.

According to an embodiment, the electronic device (e.g., the electronic device 101 of FIG. 6), may tune the frequency of an antenna signal by designing the width W3, W4, or W5 of the slot region 355 in consideration of a target frequency band of the antenna structure 350 operating as a slot antenna or interference caused by an internal structure of the electronic device.

According to an embodiment, the width W3, W4, or W5 of the slot region 355 may be substantially equal to the width of the (1-1)^{th} bulkhead 331A.

Referring to FIG. 13B, the antenna structure 350 may further include a first feed pattern 351A. The first feed pattern 351A, which is a portion to which an antenna signal is fed through the feed portion (e.g., the feed portion 370 of FIG. 6), may be a portion to which the second connector (e.g., the second connector 373 of FIG. 6) of the feed portion is connected.

According to an embodiment, the first feed pattern 351A may be a portion extending from at least a portion of the first antenna pattern 351 or the second antenna pattern 352. According to an embodiment, the first feed pattern 351A may be disposed within the slot region 355.

Referring to FIG. 13C, the antenna structure 350 may further include the first feed pattern 351A or a second feed pattern 351B. The first feed pattern 351A or the second feed pattern 351B, which is a portion to which an antenna signal is fed through the feed portion (e.g., the feed portion 370 of FIG. 6), may be a portion to which the second connector (e.g., the second connector 373 of FIG. 6) of the feed portion is connected.

According to an embodiment, the first feed pattern 351A may be a portion extending from at least a portion of the first antenna pattern 351 or the second antenna pattern 352. According to an embodiment, the first feed pattern 351A may be disposed within the slot region 355.

According to an embodiment, the second feed pattern 351B may be a portion extending from at least a portion of the first feed pattern 351A. According to an embodiment, the second feed pattern 351B may be disposed within the slot region 355. According to an embodiment, the second feed pattern 351B may extend in a direction substantially parallel to one of the second bulkhead (e.g., the second bulkhead 332 of FIG. 6) and the third bulkhead (e.g., the third bulkhead 333 of FIG. 6).

According to an embodiment, a length or width W6 (e.g., a length or width in the X-axis direction in FIG. 13C) of the second feed pattern 351B may be less than the width W5 of the slot region 355.

Referring to FIGS. 13B and 13C, the electronic device may tune the frequency of an antenna signal by adjusting a length (e.g., a length in the Z-axis direction in FIGS. 13B and 13C) of the first feed pattern 351A or a length (e.g., a length in the Z-axis direction in FIG. 13C) of the second feed pattern 351B disposed in the slot region 355.

FIG. 14A is a rear view illustrating a first inner member and an antenna structure according to an embodiment of the disclosure. FIG. 14B is a rear view illustrating a first inner member and an antenna structure according to an embodiment of the disclosure.

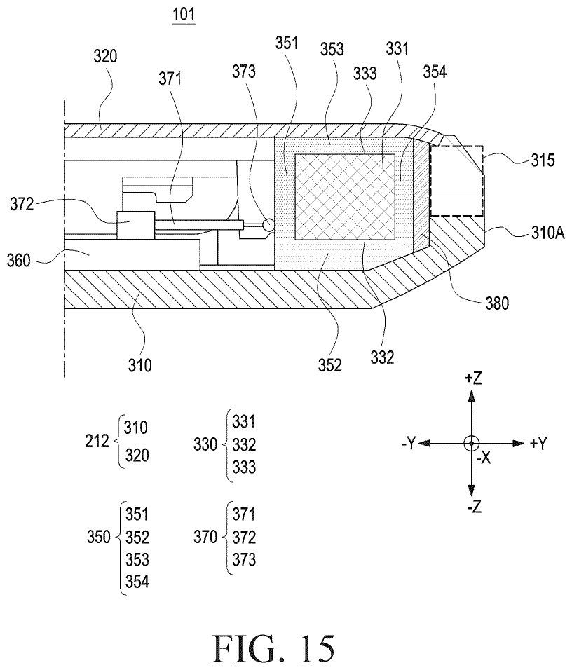

The embodiments of FIGS. 14A and 14B may be combined with one or more of the embodiments of FIGS. 1 to 13C or one or more of the embodiments of FIGS. 15 to 21.

FIGS. 14A and 14B are diagrams illustrating the first inner member 330 and the antenna structure 350 of FIGS. 6 to 9, viewed from the −Y direction to the +Y direction in FIGS. 6 to 9.

Referring to FIGS. 14A and 14B, an electronic device (e.g., the electronic device 101 of FIGS. 1 to 6) may include a first inner member 430 or 530 or an antenna structure 450 or 550.

The configurations of the first inner members 430 and 530 or the antenna structures 450 and 550 in FIGS. 14A and 14B may be partially or wholly identical to that of the first inner member 330 or the antenna structure 350 in FIGS. 6 to 13C.

Referring to FIG. 14A, the first inner member 430 may include a plurality of first bulkheads 431 (e.g., the first bulkheads 331 of FIGS. 6 to 13C), a hook structure 434 (e.g., the hook structure 334 of FIG. 4), a plurality of first air holes 436 (e.g., the first air holes 336 of FIGS. 6 to 9), or a fourth bulkhead 437.

According to an embodiment, the fourth bulkhead 437 may protrude from at least a portion of a third bulkhead (e.g., the third bulkhead 333 of FIG. 4) and be disposed in at least a portion of a first air hole 436. For example, the fourth bulkhead 437 may reduce the size of the first air hole 436 by occupying the at least portion of the first air hole 436. Accordingly, although air may be circulated through the gap between the first air hole 436 and the bulkhead, the introduction of a foreign material from the outside of the electronic device into the gap may be reduced.

According to an embodiment, the antenna structure 450 may include a first antenna pattern 451 (e.g., the first antenna pattern 351 of FIGS. 6 to 13C), a second antenna pattern 452 (e.g., the second antenna pattern 352 of FIGS. 6 to 13C), a third antenna pattern 453 (e.g., the third antenna pattern 353 of FIGS. 6 to 13C), a slot region 455 (e.g., the slot region 355 of FIGS. 11A to 13C), or a first feed pattern 451A. The first feed pattern 451A, which is a portion to which an antenna signal is fed through a feed portion (e.g., the feed portion 370 of FIG. 6), may be a portion to which a second connector (e.g., the second connector 373 of FIG. 6) of the feed portion is connected.

According to an embodiment, the first feed pattern 451A may be a portion extending from at least a portion of the first antenna pattern 351 or the third antenna pattern 353. According to an embodiment, the first feed pattern 451A may be disposed within the slot region 455.

Referring to FIG. 14B, the first inner member 530 may include a plurality of first bulkheads 531A (e.g., the first bulkheads 331 of FIGS. 6 to 13C), a hook structure 534 (e.g., the hook structure 334 of FIG. 4), a plurality of first air holes 536 (e.g., the first air holes 336 of FIGS. 6 to 9), or a fourth bulkhead 531B.

According to an embodiment, the fourth bulkhead 531B may be formed to connect first bulkheads 531 facing each other. According to an embodiment, the fourth bulkhead 531B may be disposed substantially parallel to at least one of a second bulkhead (e.g., the second bulkhead 332 of FIGS. 6 to 9) or a third bulkhead (e.g., the third bulkhead 333 of FIGS. 6 to 9).

According to an embodiment, the plurality of first air holes 536 may be surrounded by the first bulkheads 531A, the fourth bulkhead 531B, and the second bulkhead (e.g., the second bulkhead 332 of FIG. 6), or may be surrounded by the first bulkheads 531A, the fourth bulkhead 531B, and the third bulkhead (e.g., the third bulkhead 333 of FIG. 6).

According to an embodiment, the antenna structure 550 may further include a first feed pattern 551A or a second feed pattern 551B. The first feed pattern 551A or the second feed pattern 551B, which is a portion to which an antenna signal is fed through a feed portion (e.g., the feed portion 370 of FIG. 6), may be a portion to which a second connector (e.g., the second connector 373 of FIG. 6) of the feed portion is connected.

According to an embodiment, the first feed pattern 551A may be a portion extending from at least a portion of a first antenna pattern 551 or a third antenna pattern 553. According to an embodiment, the first feed pattern 551A may be disposed within the slot region 555.

According to an embodiment, the second feed pattern 551B may be a portion extending from at least a portion of the first feed pattern 551A. In an embodiment, the second feed pattern 551B may be disposed within the slot region 555. In an embodiment, at least a portion of the second feed pattern 551B may be disposed on the fourth bulkhead 531B.

According to an embodiment, the second feed pattern 551B may be a portion extending from at least a portion of the first feed pattern 551A. According to an embodiment, the second feed pattern 551B may be disposed within the slot region 555. According to an embodiment, the second feed pattern 551B may extend in a direction substantially parallel to one of the second bulkhead (e.g., the second bulkhead 332 of FIG. 6) or the third bulkhead (e.g., the third bulkhead 333 of FIG. 6).

FIG. 15 is a cross-sectional view illustrating a first housing according to an embodiment of the disclosure.

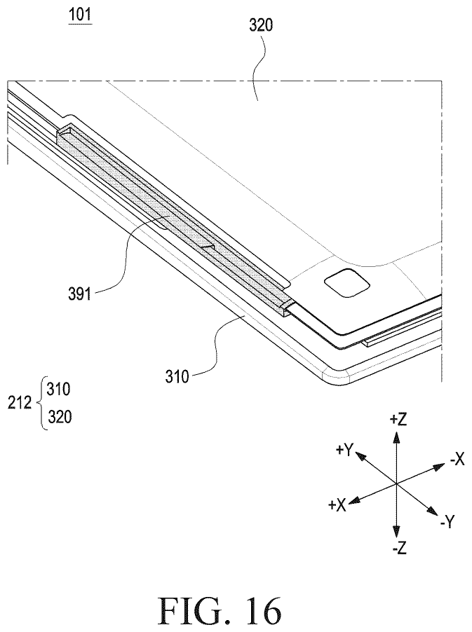

The embodiment of FIG. 15 may be combined with one or more of the embodiments of FIGS. 1 to 14B or one or more of the embodiments of FIGS. 16 to 21.

The electronic device 101 of FIG. 15 (e.g., the electronic device 101 of FIG. 6) may include the first housing 212, the first plate 310, the first slot structure 315, the second plate 320, the first inner member 330, the first bulkheads 331, the second bulkhead 332, the third bulkhead 333, the antenna structure 350, the first antenna pattern 351, the second antenna pattern 352, the third antenna pattern 353, a fourth antenna pattern 354, the circuit board 360, the feed portion 370, the coaxial cable 371, the first connector 372, the second connector 373, or a paint layer 380. The components of the electronic device 101 in FIG. 15 may be partially or wholly identical to the components of the electronic device 101 in FIG. 6.

According to an embodiment, the antenna structure 350 may further include the fourth antenna pattern 354 disposed on the front portion (e.g., a portion facing the +Y direction in FIG. 15) of the first inner member 330. The fourth antenna pattern 354 may be a conductive pattern formed on the plurality of first bulkheads 331. For example, the first inner member 330 may be defined as having at least a portion facing the first slot structure 315, and the fourth antenna pattern 354 may be defined as disposed on the at least portion of the first inner member 330.

According to an embodiment, the fourth antenna pattern 354 may be disposed on ends (e.g., ends facing the +Y direction in FIG. 15) of the first bulkheads 331. For example, at least a portion of the first antenna pattern 351 may overlap the first slot structure 315 in the direction (e.g., the +Y direction in FIG. 15) from the inside of the electronic device 101 toward the outside. According to an embodiment, the fourth antenna pattern 354 may extend from the second antenna pattern 352 or the third antenna pattern 353.

According to an embodiment, the fourth antenna pattern 354 may be configured to be electromagnetically coupled to the first antenna pattern 351. According to an embodiment, the fourth antenna pattern 354 may radiate a signal radiated from the first antenna pattern 351 (or the slot region of the first antenna pattern 351) to the outside of the electronic device 101 through the fourth antenna pattern 354 and the first slot structure 315 by capacitance formed between coupled portions of the fourth antenna pattern 354 and the first antenna pattern 351.

According to an embodiment, the electronic device 101 may further include the paint layer 380 covering the fourth antenna pattern 354. According to an embodiment, the paint layer 380 may be formed of a paint having substantially the same color as the first inner member 330. According to an embodiment, the fourth antenna pattern 354 formed on at least a portion of the first inner member 330 is visually concealed by the paint layer 380 formed in substantially the same color as the first inner member 330, so that the first inner member 330 visually viewed through the first slot structure 315 may be recognized as a single member.

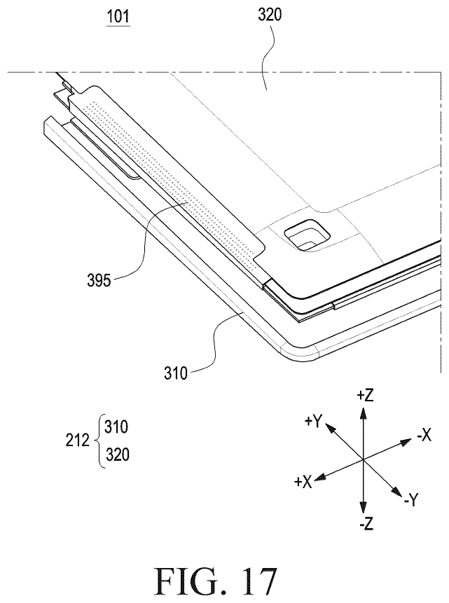

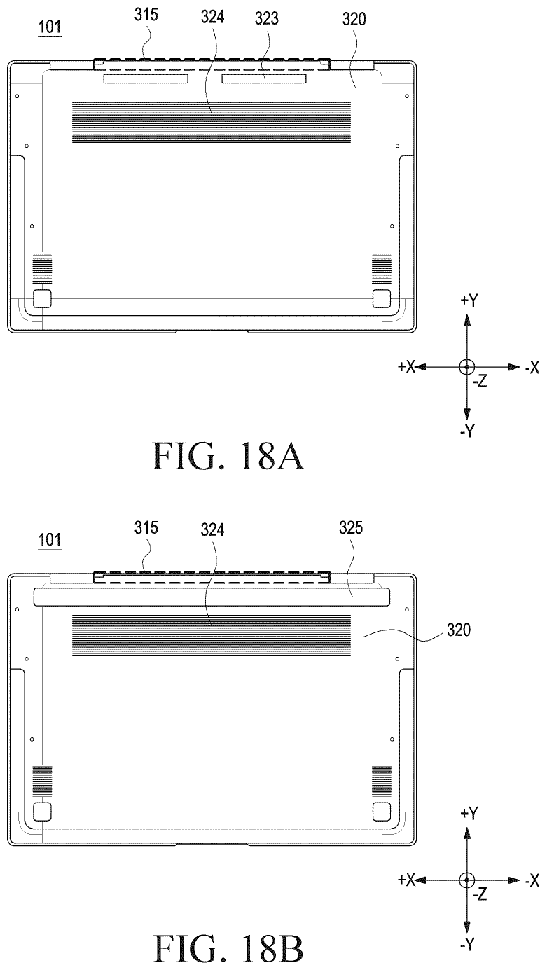

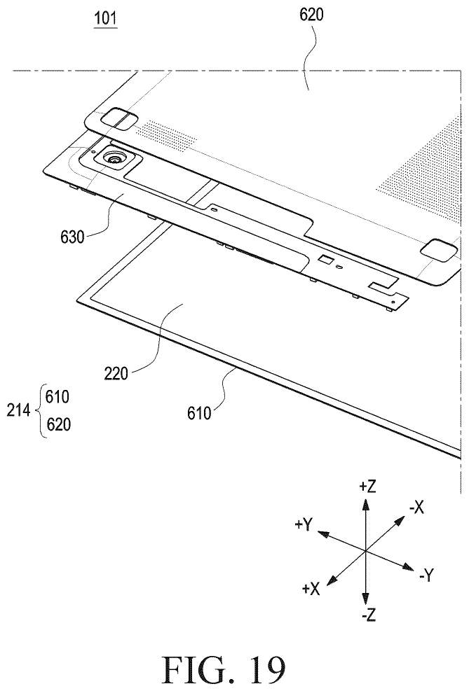

FIG. 16 is a disassembled perspective view illustrating a first housing according to an embodiment of the disclosure. FIG. 17 is a disassembled perspective view illustrating a first housing according to an embodiment of the disclosure. FIG. 18A is a diagram illustrating a second plate according to an embodiment of the disclosure. FIG. 18B is a diagram illustrating a state in which a rubber member is coupled to a second plate according to an embodiment of the disclosure. FIG. 19 is a disassembled perspective view illustrating a second housing according to an embodiment of the disclosure.

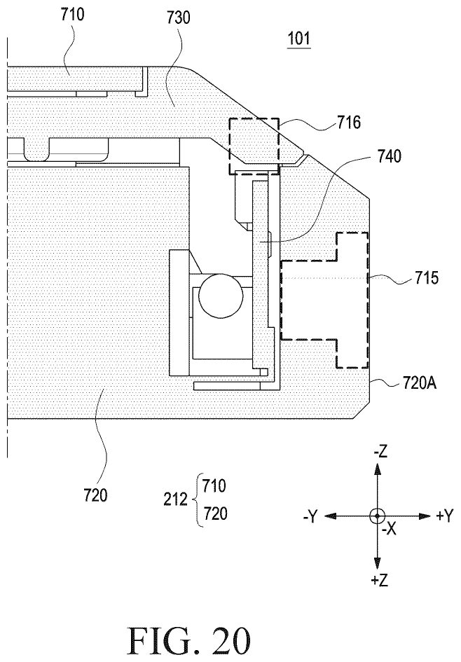

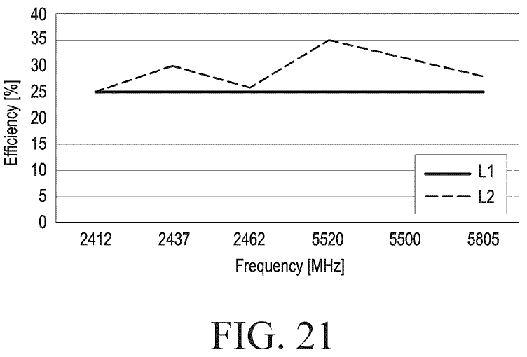

The embodiments of FIGS. 16 to 19 may be combined with one or more of the embodiments of FIGS. 1 to 15 or one or more of the embodiments of FIGS. 20 and 21.

Referring to FIGS. 16 and 17, an electronic device 101 (e.g., the electronic device 101 of FIGS. 1 to 6) may include the first housing 212 (e.g., the first housing 212 of FIGS. 2 to 6) including the first plate 310 (e.g., the first plate 310 of FIGS. 3 to 6) or the second plate 320 (e.g., the second plate 320 of FIGS. 3 to 6).

According to an embodiment, the electronic device 101 may further include a second inner member 391 or 395 (e.g., the second inner member 340 of FIG. 3).

According to an embodiment, the second inner member 391 or 395 may couple the first plate 310 and the second plate 320 to each other. In addition, the second inner member 391 or 395 may be disposed in a slot structure formed in at least a portion (e.g., edges facing the +X direction in FIGS. 16 to 17) of edges of the first plate 310 and the second plate 320.

According to an embodiment, the second inner member 391 or 395 may be formed of a non-metal material.

Referring to FIG. 16, the second inner member 391 may further include a second air hole formed in at least a portion thereof. A plurality of second air holes of the second inner member 391 may form paths in which air is introduced from the outside of the electronic device into the electronic device. For example, air introduced into the second air holes of the second inner member 391 may be discharged to the outside of the first housing 212 through the plurality of first air holes (e.g., the first air holes 336 of FIGS. 4 to 6) of the first inner member (e.g., the first inner member 330 of FIGS. 4 to 6), together with heat accumulated inside the first housing 212.

According to an embodiment, the antenna structure described with reference to FIGS. 6 to 15 as an example may be applied to the second inner member 391. For example, an antenna pattern (e.g., the first antenna pattern 351 of FIG. 6) may be disposed on a portion of the second inner member 391 facing the inside of the first housing 212, and the antenna pattern may radiate an antenna signal fed through the feed portion. For example, the antenna pattern may be configured as a slot antenna including a slot region.

According to an embodiment, the second inner member 391 may further include a second air hole formed in at least one portion thereof. A plurality of second air holes of the second inner member 391 may form a path in which air is introduced from the outside of the electronic device into the electronic device. For example, air introduced into the second air holes of the second inner member 391 may be discharged to the outside of the first housing 212 through the plurality of first air holes (e.g., the first air holes 336 of FIGS. 4 to 6) of the first inner member (e.g., the first inner member 330 of FIGS. 4 to 6) together with heat accumulated inside the first housing 212.

According to an embodiment, the antenna structure described with reference to FIGS. 6 to 15 as an example may be applied to the second inner member 391. For example, an antenna pattern (e.g., the first antenna pattern 351 of FIG. 6) may be disposed on a portion of the second inner member 391 facing the inside of the first housing 212, and the antenna pattern may radiate an antenna signal fed through the feed portion. For example, the antenna pattern may be configured as a slot antenna including a slot region.

Referring to FIG. 17, the second inner member 395 may be a speaker housing having a built-in speaker (e.g., the sound output module 155 or the audio module 170 of FIG. 1). According to an embodiment, the antenna structure described with reference to FIGS. 6 to 15 as an example may be applied to the second inner member 391. For example, an antenna pattern (e.g., the first antenna pattern 351 of FIG. 6) may be disposed on a portion of the second inner member 391 facing the inside of the first housing 212, and the antenna pattern may radiate an antenna signal fed through the feed portion. For example, the antenna pattern may be configured as a slot antenna including a slot region.

According to an embodiment, the antenna structure may be disposed in the inner member having various functions to radiate an antenna signal. In addition, the antenna structure may be disposed adjacent to the slot structure associated with various members to radiate an antenna signal through the slot structure.

Referring to FIGS. 18A and 18B, the second plate 320 may further include a plurality of third air holes 324 formed on at least a portion thereof. The plurality of third air holes 324 may form paths in which air is discharged from the inside of the second housing to the outside. According to an embodiment, to prevent or reduce heat discharged from the plurality of third air holes 324 from flowing back to the first slot structure 315, the second plate 320 may further include a second slot structure 323.

According to an embodiment, a rubber member 325 may be fixedly inserted into the second slot structure 323. According to an embodiment, when the electronic device 101 is used, paths between the first slot structure 315 and the plurality of third air holes 324 may be blocked by the rubber member 325, thereby preventing or reducing heat discharged from the first housing 212 from flowing back to the first slot structure 315. According to an embodiment, the rubber member 325 may be formed of a rubber material. However, the rubber member 325 is not limited thereto, and may be formed of various materials.

According to an embodiment, the antenna structure (e.g., the antenna structure 350 of FIGS. 6 to 9) of the electronic device 101 may be disposed adjacent to the second slot structure 323 and also radiate an antenna signal through the second slot structure 323.

Referring to FIG. 19, the second housing 214 (e.g., the second housing 214 of FIG. 2) may include a protective member 610 configured to protect the border of the display 220 (e.g., the display 220 of FIG. 2), or a third plate 620.

According to an embodiment, the protective member 610 and the third plate 620 may be coupled through a third inner member 630. According to an embodiment, the third inner member 630 may be formed of a non-metal material. In addition, the third inner member 630 may be disposed in a slot structure formed between the protective member 610 and the third plate 620.

According to an embodiment, an antenna structure (e.g., the antenna structure 350 of FIGS. 6 to 9) may be formed in a portion of the third inner member 630 facing the inside of the second housing 214. According to an embodiment, the antenna structure (e.g., the antenna structure 350 of FIGS. 6 to 9) of the electronic device 101 may be disposed adjacent to the slot structure formed between the protective member 610 and the third plate 620 to radiate an antenna signal through the slot structure.

FIG. 20 is a cross-sectional view illustrating a first housing according to an embodiment of the disclosure.

The embodiment of FIG. 20 may be combined with one or more of the embodiments of FIGS. 1 to 19 or one or more of the embodiment of FIG. 21.

Referring to FIG. 20, the electronic device 101 (e.g., the electronic device 101 of FIGS. 1 to 6) may include the first housing 212 (e.g., the first housing 212 of FIGS. 1 to 6).

According to an embodiment, the first housing 212 may include a first plate 710 (e.g., the first plate 310 of FIGS. 4 to 6) or a second plate 720 (e.g., the second plate 720 of FIGS. 4 to 6).

According to an embodiment, the first plate 710 and the second plate 720 may be coupled through a first inner member 730 (e.g., the first inner member 330 of FIGS. 4 to 6).

According to an embodiment, the electronic device 101 may include a circuit board 740 (e.g., the circuit board 360 of FIG. 6). According to an embodiment, an antenna structure (e.g., the antenna structure 350 of FIG. 6) may be formed on a circuit board 740. For example, the circuit board 740 may include at least one antenna pattern (e.g., a conductive pattern).

According to an embodiment, an antenna signal radiated from the antenna structure of the circuit board 740 may be radiated to the outside of the electronic device 101 through a first slot structure 715 formed on a side surface 720A of the second plate 720.

According to an embodiment, an antenna signal radiated from the antenna structure of the circuit board 740 may be radiated to the outside of the electronic device 101 through at least a portion of the first inner member 730 disposed in a second slot structure 716 formed between the first plate 710 and the second plate 720.

FIG. 21 is a diagram of a graph comparing the antenna performance of an electronic device in terms of efficiency (y-axis) at different frequencies (x-axis) according to an embodiment of the disclosure with the antenna performance of a general electronic device.

The embodiment of FIG. 21 may be combined with one or more of the embodiments of FIG. 1 to FIG. 20.

Referring to FIG. 21, it may be identified that an antenna efficiency L2 of the electronic device of the disclosure is higher than an antenna efficiency L1 of the general electronic device (e.g., an electronic device with a portion of a metal housing parted). The horizontal axis of the graph of FIG. 21 may represent frequency, and the vertical axis of the graph of FIG. 21 may represent efficiency. For example, it may be identified that the antenna efficiency L2 of the electronic device of the disclosure is higher than the antenna efficiency L1 of the general electronic device in a frequency range of about 2412 MHz to about 5805 MHz in antenna performance.

An electronic device having communication functions, such as a portable terminal (e.g., a notebook electronic device), becomes smaller and lighter in order to maximize the portability and convenience of a user, and integrated components are disposed in an increasingly smaller space, for high performance.

Further, to improve aesthetics and supplement rigidity, electronic devices are increasingly adopting metal housing materials. When the exterior of an electronic device is formed of a metal housing, a separate structure (a non-metal material) for antenna signal radiation should be disposed in a portion of the metal housing to radiate an antenna signal. Since this structure is visually exposed from the exterior of the product, the aesthetics of the electronic device may be reduced, and since a portion of the metal housing is replaced with the separate structure, there is a concern that the mechanical rigidity of the electronic device may be weakened.

According to an embodiment of the disclosure, an antenna structure in which a coupling structure for plates and an arrangement structure of an antenna pattern may be implemented through a single component, and an electronic device including the same may be provided.

However, the problem to be solved in the disclosure is not limited to the problem mentioned above, and may be determined in various ways without departing from the spirit and scope of the disclosure.

According to an embodiment of the disclosure, since an antenna signal from a slot antenna may be radiated through a first slot structure, antenna radiation performance may be improved.

According to an embodiment of the disclosure, since a coupling structure for plates and an arrangement structure of an antenna pattern may be implemented through one component, fewer components may be required.

According to an embodiment of the disclosure, an electronic device (e.g., the electronic device 101 of FIGS. 1 to 6) may include a first plate (e.g., the first plate 310 of FIGS. 3 to 6), a second plate (e.g., the second plate 320 of FIGS. 3 to 6), a first inner member (e.g., the first inner member 330 of FIGS. 3 to 11B), or a first antenna pattern (e.g., the first antenna pattern 351 of FIGS. 6 to 11B, the first antenna pattern 451 of FIG. 14B, or the first antenna pattern 551 of FIG. 14C). The second plate may be disposed to form a first slot structure (e.g., the first slot structure 315 of FIGS. 5 and 6) between the first plate and at least a portion of the second plate. The first inner member may be coupled to the first plate and the second plate. At least a portion of the first inner member may be disposed to face the first slot structure. The first inner member may be formed of a non-metal material. The first antenna pattern may be disposed on another portion facing an opposite direction to the at least portion of the first inner member.

According to an embodiment, the electronic device may further include a circuit board (e.g., the circuit board 360 of FIG. 6) disposed between the first plate and the second plate. The electronic device may further include a feed portion configured to electrically connect the circuit board and the first antenna pattern.

According to an embodiment, the first inner member may include a plurality of first air holes (e.g., the first air holes 336 of FIGS. 4 and 5 or the air holes 336 of FIGS. 7 to 9) formed in at least a portion of the first inner member.

According to an embodiment, the first antenna pattern may include a slot region (e.g., the slot region 355 of FIG. 9) formed in at least a portion of the first antenna pattern.

According to an embodiment, at least a portion of the slot region may be disposed to overlap the first slot structure in a direction from an inside of the electronic device toward an outside of the electronic device.

According to an embodiment, the first inner member includes a plurality of first air holes formed in at least a portion of the first inner member, and the at least a portion of the slot region may be disposed to overlap at least one of the plurality of first air holes in the direction from the inside of the electronic device toward the outside of the electronic device.

According to an embodiment, the at least a portion of the slot region may be disposed not to overlap the plurality of first air holes in the direction from the inside of the electronic device toward the outside of the electronic device.

According to an embodiment, the electronic may further include a first feed pattern (e.g., the first feed pattern 351A of FIG. 13B, the first feed pattern 451A of FIG. 14B, or the first feed pattern 551A of FIG. 14C) extending from the first antenna pattern. At least a portion of the first feed pattern may be disposed in the slot region.

According to an embodiment, the electronic device may further include a second feed pattern (e.g., the second feed pattern 351B of FIG. 14A or the second feed pattern 551B of FIG. 14C) extending from the first feed pattern.

According to an embodiment, the electronic device may further include a second antenna pattern (e.g., the second antenna pattern 352 of FIGS. 6 to 11B, the second antenna pattern 452 of FIG. 14B, or the second antenna pattern 552 of FIG. 14C) extending from the first antenna pattern. At least a portion of the second antenna pattern may be configured to contact the first plate.

According to an embodiment, the electronic device may further include a third antenna pattern (e.g., the third antenna pattern 353 of FIGS. 6 to 11B, the third antenna pattern 453 of FIG. 14B, or the third antenna pattern 553 of FIG. 14C) extending from the first antenna pattern. At least a portion of the third antenna pattern may be configured to contact the second plate.

According to an embodiment, the electronic device may further include a fourth antenna pattern (e.g., the fourth antenna pattern 354 of FIG. 15) disposed on the at least a portion of the first inner member.

According to an embodiment, the electronic device may further include a paint layer (e.g., the paint layer 380 of FIG. 15) disposed to cover the fourth antenna pattern.

According to an embodiment, the paint layer may have a color substantially the same as the first inner member.

According to an embodiment, the electronic device may further include a communication module (e.g., the communication module 190 of FIG. 1) electrically connected to the first antenna pattern.

According to an embodiment, the electronic device tunes a frequency of an antenna signal by adjusting a length of the first feed pattern (e.g., the first feed pattern 351A of FIG. 13B, the first feed pattern 451A of FIG. 14B, or the first feed pattern 551A of FIG. 14C) extending from the first antenna pattern.

According to an embodiment, the electronic device tunes a frequency of an antenna signal by adjusting a length of the second feed pattern (e.g., the second feed pattern 351B of FIG. 14A or the second feed pattern 551B of FIG. 14C) extending from the first antenna pattern.

According to an embodiment, the first inner member includes a plurality of first bulkheads (e.g., the plurality of first bulkheads 331 of FIG. 3), a second bulkhead (e.g., the second bulkhead 332 of FIG. 3) disposed on first ends of the plurality of first bulkheads, and a third bulkhead (e.g., the third bulkhead 333 of FIG. 3) disposed on second ends of the first plurality of first bulkheads.

According to an embodiment, the electronic device includes a hook structure (e.g., the hook structure 334 of FIG. 3) protruding from at least a portion of the third bulkhead and the plurality of first bulkheads are spaced apart from one another in a width direction of the electronic device to form a plurality of first air holes.

According to an embodiment of the disclosure, an electronic device (e.g., the electronic device 101 of FIGS. 1 to 6) may include a first plate (e.g., the first plate 310 of FIGS. 3 to 6), a second plate (e.g., the second plate 320 of FIGS. 3 to 6), a first inner member (e.g., the first inner member 330 of FIGS. 3 to 11B), a circuit board (e.g., the circuit board 360 of FIG. 6), an antenna structure (e.g., the antenna structure 350 of FIGS. 6 to 11B), or a feed portion (e.g., the feed portion 370 of FIG. 6). The second plate may be disposed to form a first slot structure (e.g., the first slot structure 315 of FIGS. 5 and 6) between the first plate and at least a portion of the second plate. The first inner member may be coupled to the first plate and the second plate. At least a portion of the first inner member may be disposed to face the first slot structure. The first inner member may be formed of a non-metal material. The circuit board may be disposed between the first plate and the second plate. The antenna structure may be formed in at least a portion of the first inner member. The feed portion may be configured to feed an antenna signal from the circuit board to the antenna structure.

According to an embodiment, at least one of the first plate or the second plate may provide a ground plane for the antenna structure.

According to an embodiment, the antenna structure may be configured as a slot antenna.

According to an embodiment, the first inner member may include a hook structure (e.g., the hook structure 334 of FIG. 4) for coupling to the first plate or the second plate.

According to an embodiment, the feed portion may include a coaxial cable (e.g., the coaxial cable 371 of FIG. 6).

While specific embodiments have been described above in the detailed description of the disclosure, it will be apparent to those skilled in the art that many variations may be made without departing from the scope of the disclosure.

What is claimed is:

1. An electronic device comprising:
a first plate;
a second plate disposed to form a first slot structure between the first plate and at least a portion of the second plate;
a first inner member formed of a non-metal material, and coupled to the first plate and the second plate, wherein at least a portion of the first inner member faces the first slot structure; and
a first antenna pattern disposed on another portion facing an opposite direction to the at least a portion of the first inner member.

2. The electronic device of claim 1, further comprising:
a circuit board disposed between the first plate and the second plate; and
a feed portion configured to electrically connect the circuit board and the first antenna pattern.

3. The electronic device of claim 1, wherein the first inner member includes a plurality of first air holes formed in at least a portion of the first inner member.

4. The electronic device of claim 1, wherein the first antenna pattern includes a slot region formed in at least a portion of the first antenna pattern.

5. The electronic device of claim 4, wherein at least a portion of the slot region is disposed to overlap the first slot structure in a direction from an inside of the electronic device toward an outside of the electronic device.

6. The electronic device of claim 5, wherein the first inner member includes a plurality of first air holes formed in at least a portion of the first inner member, and wherein the at least a portion of the slot region is disposed to overlap at least one of the plurality of first air holes in the direction from the inside of the electronic device toward the outside of the electronic device.

7. The electronic device of claim 6, wherein the at least a portion of the slot region is disposed not to overlap the plurality of first air holes in the direction from the inside of the electronic device toward the outside of the electronic device.

8. The electronic device of claim 7, further comprising a first feed pattern extending from the first antenna pattern, wherein at least a portion of the first feed pattern is disposed in the slot region.

9. The electronic device of claim 8, further comprising a second feed pattern extending from the first feed pattern.

10. The electronic device of claim 1, further comprising a second antenna pattern extending from the first antenna pattern, wherein at least a portion of the second antenna pattern is configured to contact the first plate.

11. The electronic device of claim 10, further comprising a third antenna pattern extending from the first antenna pattern, wherein at least a portion of the third antenna portion is configured to contact the second plate.

12. The electronic device of claim 11, further comprising a fourth antenna pattern disposed on the at least a portion of the first inner member.

13. The electronic device of claim 12, further comprising a paint layer disposed to cover the fourth antenna pattern.

14. The electronic device of claim 13, wherein the paint layer has a color substantially the same as the first inner member.

15. The electronic device of claim 1, further comprising a communication module electrically connected to the first antenna pattern.

16. The electronic device of claim 8, wherein the electronic device tunes a frequency of an antenna signal by adjusting a length of the first feed pattern extending from the first antenna pattern.

17. The electronic device of claim 9, wherein the electronic device tunes a frequency of an antenna signal by adjusting a length of the second feed pattern extending from the first antenna pattern.

18. The electronic device of claim 1, wherein the first inner member comprises a plurality of first bulkheads, a second bulkhead disposed on first ends of the plurality of first bulkheads, and a third bulkhead disposed on second ends of the first plurality of first bulkheads.

19. The electronic device of claim 18, further comprising a hook structure protruding from at least a portion of the third bulkhead, wherein the plurality of first bulkheads are spaced apart from one another in a width direction of the electronic device to form a plurality of first air holes.

20. An electronic device comprising:
a first plate;
a second plate, wherein the second plate is disposed to form a first slot structure between the first plate and at least a portion of the second plate;
a first inner member coupled to the first plate and the second plate, at least a portion of the first inner member being disposed to face the first slot structure, the first inner member being formed of a non-metal material;
a circuit board disposed between the first plate and the second plate;
an antenna structure formed in at least a portion of the first inner member; and
a feed portion configured to feed an antenna signal from the circuit board to the antenna structure.
